(19) United States
(12) Patent Application Publication
(10) Pub. No.: US 2005/0228860 A1
(43) Pub. Date: Oct. 13, 2005

(54) Methods and apparatus for geographically based Web services

(76) Inventors: Kimmo Hamynen, Espoo (FI); Roland Geisler, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/822,641

(22) Filed: Apr. 12, 2004

(51) Int. Cl. G06F 15/16

(52) U.S. Cl. 709/203

(57) ABSTRACT

A system and method provides location sensitive Web content in response to receiving location based Web content requests. Location information derived from multiple sources by a mobile terminal is included in a Web content request. Location tagged Web content is then retrieved via a Web server/search engine and filtered in accordance with the location/keyword information provided in the content request.

### FIELD OF THE INVENTION

This invention relates in general to Web functions, and more particularly to a system and method that provides geographically based Web functions.

### BACKGROUND OF THE INVENTION

Where mobile telephones were perhaps viewed by many as a luxury when first introduced into the marketplace, they are today viewed by our society as very important, convenient, and useful tools. A great number of people now carry their mobile devices with them wherever they go. This popularity of wireless communication has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow voice communication, but also facilitate messaging, multimedia communications, e-mail, Internet browsing, and access to a wide range of wireless applications and services.

Some applications, content, and services that might be available for use on a mobile device may be of little value, however, until the user is placed in a particular context or location in which such applications, content and/or services may be useful. This has led to a concept generally referred to as location-based services. Location-based services have not yet had time to develop into mature applications, since perhaps the majority of Web based search engines today operate on the assumption that the user is in a fixed location. Thus, location of the user is not dynamic, but is rather assumed to be the location, for example, of the server that is hosting the Web search engine.

Conventional location based services provide portals which extract the Uniform Resource Locator (URL) address strings from a Web resource, convert the address strings to geographical coordinates through lookup functions executed on location information repositories, generate metatags which represent the location of the resource, and then index the metatags for future searching or mapping. Thus, only after a relatively large amount of processing are the location based resources available for selection.

It can be seen, therefore, that conventional location-based service operations have limitations that impair the current state of the art. One prior art solution focuses primarily on the locations of the services offered rather than on the relative location of the user to the services offered, while another prior art solution requires a relatively large amount of location based processing to obtain the results desired.

Accordingly, there is a need in the mobile communications industry for location based services that are adaptively focused on the user's location, or other location information provided by the user. A further need exists for a system and methodology that provides location based services while reducing the overall processing required to provide the service. The present invention fulfills these and other needs, and offers other advantages over the prior art location based service approaches.

### SUMMARY OF THE INVENTION

To overcome limitations in the prior art described above, and to overcome other limitations that will become apparent upon reading and understanding the present specification, the present invention discloses a system and method for providing geographically based Web functions. The present invention allows linkage of geographically tagged Web content to a location based Web content request. In this manner, a geographical dimension is added to the mobile browsing experience that provides many value added services and functions to today's mobile terminal user.

In accordance with one embodiment of the invention, a method of accessing position relevant Web content comprises obtaining a location update relative to a position of a mobile terminal, forming location criteria from the location update, including the location criteria in a Web content request from the mobile terminal, filtering results from the Web content request according to the location criteria to form the position relevant Web content, and providing the position relevant Web content to the mobile terminal.

In accordance with another embodiment of the invention, a geographically based Web content system comprises a mobile terminal geographically located within the Web content system, a Web server adapted to receive Web content requests from the mobile terminal, and a search engine coupled to the Web server and adapted to gather location tagged Web content in response to the Web content requests. The location tags of the Web content gathered conform to geographical criteria expressed by the mobile terminal in the Web content requests.

In accordance with another embodiment of the invention, a mobile terminal is wirelessly coupled to a network which includes location tagged Web content. The mobile terminal comprises a memory capable of storing a location update module and a geographical search module, a processor coupled to the memory and configured by the location update module to maintain position information associated with the mobile terminal and configured by the geographical search module to request the location tagged Web content that relates to the position of the mobile terminal, and a transceiver configured to receive the location tagged Web content from a Web server.

In accordance with another embodiment of the invention, a computer-readable medium having instructions stored thereon which are executable by a mobile terminal for requesting location based Web content performs steps comprising obtaining location updates relative to a position of the mobile terminal, defining an area of interest surrounding the position of the mobile terminal, and requesting location based Web content that conforms to the area of interest.

In accordance with another embodiment of the invention, a Web server is coupled to a network to facilitate a location based Web content search. The Web server comprises means for receiving location based Web content requests containing location criteria associated with a location of a mobile terminal, means for communicating the location based Web content requests to a search engine, means for receiving responses from the search engine in response to the location based Web content requests, and means for filtering the responses to conform to the location criteria.

In accordance with another embodiment of the invention, a computer-readable medium having instructions stored thereon which are executable by a Web server performs steps comprising receiving Web content requests containing location criteria associated with a location of a mobile terminal, communicating the Web content requests to a search engine, receiving responses from the search engine in response to the Web content requests, and filtering the responses to conform to the location criteria.

In accordance with another embodiment of the invention, a mobile terminal is wirelessly coupled to a network which includes Web content. The mobile terminal comprises a memory capable of storing a location update module and a geographical search module, a processor coupled to the memory and configured by the location update module to maintain position information associated with the mobile terminal, and a user interface that is adapted to display menu options whose selection configures the geographical search module to issue a search request used to locate the Web content. The menu options comprise a general search option that returns Web content irregardless of location tags associated with the Web content and the position information associated with the mobile terminal, a location search option that returns Web content whose location tags comply with location information provided in the search request, and a user centric search option that returns Web content whose location tags comply with the position information associated with the mobile terminal that is provided in the search request.

In accordance with another embodiment of the invention, a mobile terminal is wirelessly coupled to a network which includes Web content. The mobile terminal comprises a memory capable of storing a location update module and a geographical search module, a processor coupled to the memory and configured by the location update module to maintain a position of the mobile terminal, and a user interface that is adapted to display menu options whose selection determines a search request used to locate the Web content. The menu options comprise an automatic search option that configures the geographical search module to automatically issue the search request depending upon the position of the mobile terminal. A HyperText Transport Protocol (HTTP) header in the search request includes the position of the mobile terminal.

In accordance with another embodiment of the invention, a geographically based Web content system comprises a mobile terminal geographically located within the Web content system, a Web server coupled to receive Web content requests from the mobile terminal, and a content provider coupled to the Web server. The content provider contains Web pages that include eXtensible Markup Language (XML) to define location information associated with the Web pages.

In accordance with another embodiment of the invention, a mobile terminal is wirelessly coupled to a network which includes location tagged Web content. The mobile terminal comprises a memory capable of storing a location update module and a geographical search module, a processor coupled to the memory and configured by the location update module to maintain a position of the mobile terminal, and a user interface that is adapted to display menu options whose selection determines a search request used to locate the location tagged Web content. The menu options comprise a tour search option that configures the geographical search module to issue an alarm once the location update module has determined that the mobile terminal has come within a programmable proximity to a location indicated by the location tagged Web content.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates an exemplary wireless network environment in accordance with the present invention;

FIG. 2 illustrates an exemplary Web content access network in accordance with the present invention;

FIG. 3 illustrates an exemplary location sensitive block diagram in accordance with the present invention;

FIG. 4 illustrates exemplary menu options offered by a mobile terminal in accordance with the present invention;

FIG. 5 illustrates exemplary map data that may be rendered onto a display of a mobile terminal in accordance with the present invention;

FIG. 6 illustrates an exemplary text to voice diagram in accordance with the present invention;

FIG. 7 illustrates an exemplary flow diagram of a method in accordance with the present invention;

FIG. 8 illustrates a representative mobile computing arrangement suitable for initiating and managing location based functionality in accordance with the present invention; and

FIG. 9 is a representative computing system capable of carrying out location based Web content functions according to the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to location enhanced access to Web content, such as applications and services, that are themselves location tagged. In general, the Web content contains location information, e.g., location tags embedded within the eXtensible Hypertext Markup Language (XHTML) content. The location tags can then be compared to the location information contained within the content request when determining which content is position relevant to the requested location. Keywords may also be associated with the location based content search, such that Web content relating to both the keyword and the relevant location of interest may be found. The invention is also beneficial for users who expect to return (whether frequently or infrequently) to one or more particular locations, as the mobile terminal itself will recognize that it has returned to such a location and can automatically re-configure itself in relation to its current location.

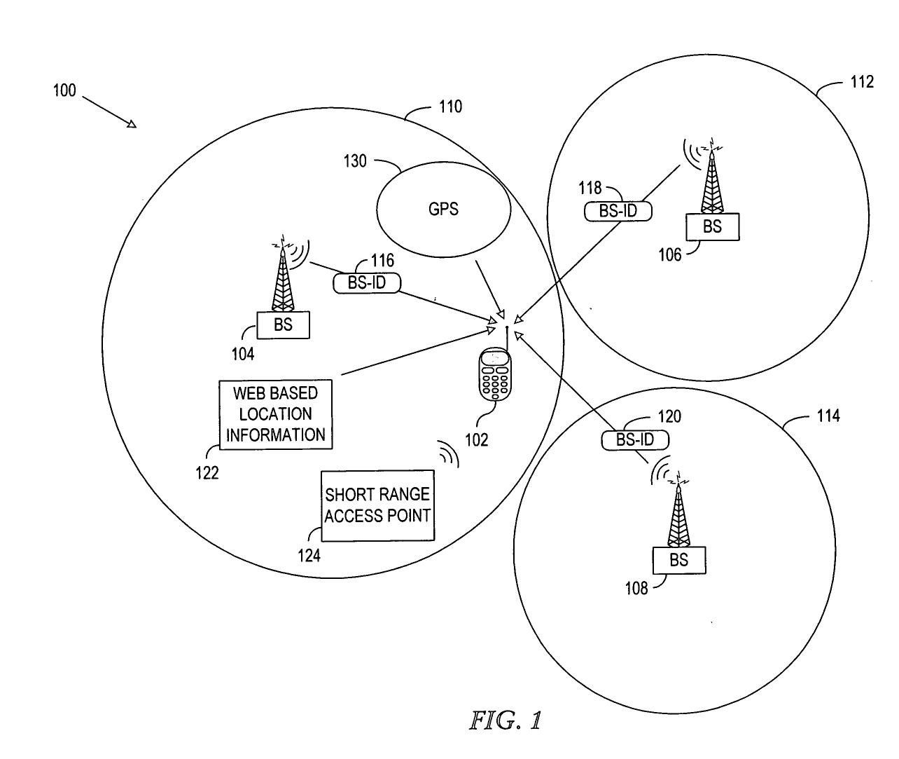

In accordance with the present invention, the location of the mobile terminal is determined by using one of several available methodologies. The mobile terminal's location is then used in combination with a keyword search to determine which Web pages may be of interest to the mobile user, based upon the Web pages' location tag and the keyword used. FIG. 1 is a block diagram generally illustrating a number of representative examples in which a mobile terminal can receive location information about itself. The examples set forth in FIG. 1 are provided as representative examples to facilitate an understanding of this aspect of the present invention, however it should be recognized that the present invention is not limited to these representative examples.

FIG. 1 depicts a wireless network environment 100, which may include a cellular network such as the Global System for Mobile Communication (GSM). A portion of the description provided in connection with FIG. 1 is described in terms of a cellular network such as GSM, but the principles described herein are equally applicable to other cellular/wireless networks such as, for example, Enhanced Data rate for GSM Evolution (EDGE), Personal Communications Service (PCS), and other current or future cellular network technologies. For purposes of discussion and not of limitation, FIG. 1 will be described in terms of a GSM system.

In a mobile radio network such as a GSM network, the area to be covered is divided into multiple areas, generally referred to as “cells.” The mobile radio network is assigned a set of frequencies, and each cell is assigned one (or more) of these frequencies. Neighboring cells will not use the same frequencies, and frequencies are re-used only where the distance is sufficiently large as to avoid interference. When a mobile terminal moves from one cell to another, an automatic channel/frequency change will occur, which is generally referred to as “handoff” or “handover.”

In general, a GSM network includes a number of primary subsystems, including a radio subsystem (RSS), a switching subsystem (SS), and an operation subsystem (OSS). The SS connects the wireless network with other networks such as standard public networks, performs handovers between different Base Station Subsystems (BSSs), includes world-wide user location functions, and supports charging, billing, and roaming of users between different service providers. The SS includes elements such as a Mobile Services Switching Center (MSC), a Home Location Register (HLR), Visitor Location Register (VLR), and other elements known in the art. The OSS provides functions for network operation and maintenance, and includes elements such as an Operation and Maintenance Center (OMC), Authentication Center (AuC), Equipment Identity Register (EIR), and other elements known in the art. The SS and OSS, being known in the art and not of particular relevance to the instant discussion, need not described in further detail.

The RSS includes radio-specific elements, such as the mobile terminals and the Base Station Subsystem (BSS). Referring to FIG. 1, a mobile terminal 102 includes the hardware, software, Subscriber Identity Module (SIM), etc. necessary to communicate with the GSM network. The GSM network includes multiple BSSs, each of which is controlled by a Base Station Controller (BSC). The BSS is responsible for maintaining radio connections to the mobile terminals, coding and decoding, etc. The BSS is a logical entity physically implemented via the BSC and a set of Base Transceiver Stations (BTS), commonly referred to simply as Base Stations (BS), that are controlled by the BSC. In FIG. 1, three of the many available base stations are illustrated, including BS 104, 106, 108. Each BS includes the radio equipment, such as antennas, signal processing, amplifiers, etc. used to facilitate the communication between the BSC and the mobile terminals. The wireless area served by a BS is generally referred to as a cell, such that cell 110 is served by BS 104, cell 112 is served by BS 106, and cell 114 is served by BS 108.

In a cellular network such as the exemplary GSM network portion illustrated in FIG. 1, a number of identifiers are used to identify the various network constituents. For example, the mobile terminals 102 are generally associated with an equipment identifier, and the user of the mobile terminal 102 is generally associated with a subscriber identifier (such as that provided by a SIM) as well as with an identifier such as a telephone number. In addition, several other identifiers are defined for managing subscriber mobility and addressing other network elements.

One embodiment of the invention involves establishing one or more communication channels between mobile terminal 102 and BS 104-108 which can then be used by the mobile terminal 102 to identify its position. For example, the mobile terminal 102 can perform signal strength measurements for the channels associated with BS 104-108, such that the mobile terminal 102 may “triangulate” its position with respect to the reported positions of BS 104-108, where differentiation between BS 104-108 is accomplished via BS-ID 116-120, respectively. Alternately, the location information may be generated at one of BS 104-108 and subsequently reported to mobile terminal 102.

In an alternate embodiment, the user of mobile terminal 102 may utilize a mobile browser to access Web based location information 122, such as a mapping tool offered at, for example, URL: “www.mapquest.com”. In such an instance, the user of mobile terminal 102 may simply locate his position (or any other position of interest) on an electronic map provided by Web based location information 122 using pointing and/or cursor commands available on his mobile terminal. Once the position of interest is identified on the electronic map, Web based location information 122 converts the position into location coordinates, or other position indicia that are compatible with mobile terminal 102, and then provides the position information to mobile terminal 102.

In another embodiment, short range technologies such as Wireless Local Area Network (WLAN), Bluetooth, or other radio technologies such as Radio Frequency Identification (RFID), may be used to provide location information to mobile terminal 102. Bluetooth, for example, is a computing and telecommunications industry specification that describes how mobile phones and other mobile terminals can interconnect with each other and with home and business phones/computers using a short-range wireless connection. A Bluetooth hot spot is an area that has a readily accessible wireless network available to multiple people within that area. The Bluetooth hot spot is thus a location such that when a device equipped with Bluetooth circuitry, e.g., mobile terminal 102, is within range of a Bluetooth “access point,” e.g., short range access point 124, the user can connect wirelessly to the access point to gain location information associated with the access point. Thus, once mobile terminal 102 is within range of short range access point 124, the location of short range access point 124 may be transmitted to mobile terminal 102, so that the location of mobile terminal 124 is made equivalent to the location of the access point. The present invention is further applicable to technologies where a greater degree of location accuracy is desired, e.g., through the use of Global Positioning System (GPS) 130. In such an instance, mobile terminal 102 may communicate with GPS 130 through an internal GPS receiver (not shown) to receive location information that is accurate to within several meters to several centimeters depending upon the particular algorithm that is used.

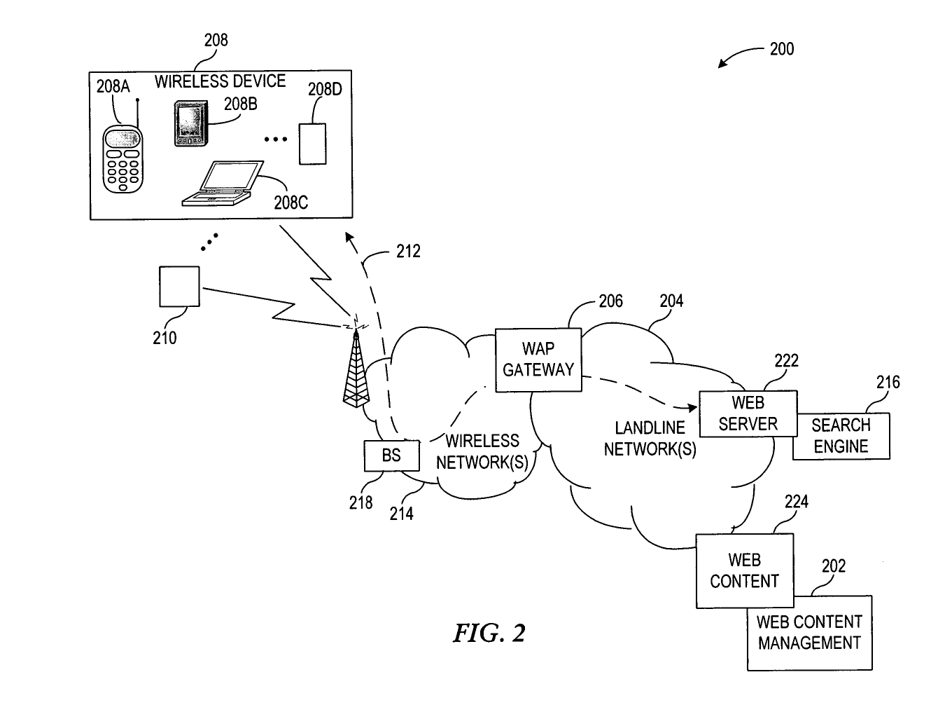

As stated above, Web content accessed by mobile terminal 102 is tagged with location information in accordance with the present invention. Exemplary network 200 facilitating such Web content access is illustrated in FIG. 2, whereby mobile terminals 208, 210 are provided access to location based Web content 224 via Web server 222. In the example of FIG. 2, Web content 224 and associated Web content management 202 may be coupled to a landline network 204, such as the Internet, via Web server 222. WAP gateway 206 serves as the access point between mobile operator network 214 and landline network 204, whereby messages 212, e.g., HyperText Transport Protocol (HTTP) messages, sent from mobile terminals 208, 210 are sent through WAP gateway 206. Terminals 208, 210 may include mobile phones 208A, Personal Digital Assistants (PDA) 208B, portable computing devices 208C, or other 208D wireless devices.

HTTP messages 212 may include keyword based, search requests directed to Web server 222 that are subsequently forwarded onto search engine 216, where search engine 216 may co-exist with Web server 222. Such search requests may include location information associated with mobile terminals 208, 210 as discussed above in relation to mobile terminal 102 of FIG. 1. One operation of search engine 216 is to perform keyword searches based upon the keyword(s) provided within the search request and to further perform filtering operations on the results of the search that conform to the location information included in the search request. In other words, each of the search hits that are registered during the keyword search include their own location tag. These location tags are then compared to the location information provided in the search request for final location verification. Once all search hits that conform to the location requirements defined by the search request have been found, they are then reported to mobile terminals 208, 210 for further processing.

In one embodiment according to the present invention, the location information provided by mobile terminal 208, 210 may include the coordinates of only one particular location of interest. In such an instance, search engine operations performed by search engine 216 filters the keyword search results according to the location tag associated with each search result. Only those search hits, and related links, whose location tags match the location information provided in the search request will be reported. The location tag may be represented, for example, by latitude/longitude (lat/long) coordinates, such as may be provided by GPS 130, or conversely may be represented by location attributes such as landmark titles, street address, city names, etc. In the event that location attributes are provided instead of location coordinates, Web server 222 may contact additional network entities (not shown), such as location servers and URLs providing map function capability, to convert the location attributes to their associated lat/long coordinates prior to submission to search engine 216.

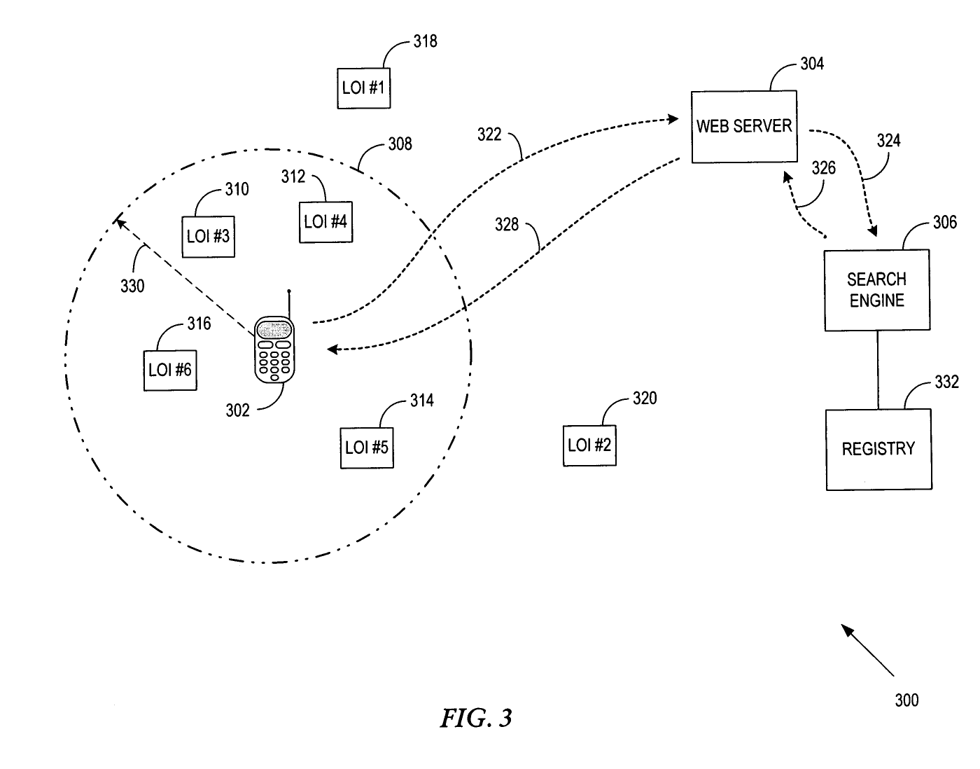

In an alternate embodiment, the location information provided within the search request may include an Area of Interest (AOI), whereby all locations within the AOI that match the keyword are reported to mobile terminals 208, 210. Such an exemplary embodiment is illustrated by block diagram 300 of FIG. 3, where Locations of Interest (LOI) 310-320 are distributed as shown and are associated with URLs that are registered within registry 332. Mobile terminal 302 may receive regular updates of its own position in accordance with the discussion relating to FIG. 1 and is in communication with Web server 304 in accordance with the discussion relating to FIG. 2.

Search engine 306 accepts search request 324 from Web server 304 that contains the AOI and keyword indicated by mobile terminal 302 in message 322. Depending on the particular parameters contained with the AOI, search engine 306 directs its search not only according to the keyword supplied within request 324, but also in accordance with the AOI specified in request 324. In one embodiment, request 324 may represent an HTTP request having a geographical header field, e.g., <MyLocation>, defined as <MyLocation=60°08′62″N; 24°38′64″E>, where the location of mobile terminal 302 is expressed within the HTTP header with lat/long coordinates. In addition, an accuracy header field, e.g., <LocationAccuracy>, may also be contained within HTTP request 324 that controls the area surrounding the location defined by the <MyLocation> header field.

In one embodiment, the <LocationAccuracy> header field may, for example, define radius 330 such that the particular AOI contained within HTTP request 324 defines a circular area having circumference 308. As such, LOI 310-316 would fall within the requested AOI, since the datum point marked by the <MyLocation> header field defines the center of circumference 308 and radius 330 sweeps an arc that encompasses LOIs 310-316. Once all of the locations within the AOI defined by the <MyLocation> and <LocationAccuracy> header fields of HTTP request 324 have been located by search engine 306, a list containing LOIs 310-316 results. The list is then further filtered in accordance with the keyword information supplied by HTTP request 324, such that locations matching the keyword of interest that lie within the AOI specified are returned to Web server 304 via message 326. The final search results are then transmitted to mobile terminal 302 via message 328, whereby only those LOIs falling within circumference 308 having Web content that matches the keyword are reported.

It can be seen, that the present invention is particularly useful when mobile terminal 302 is traveling within an area that is unfamiliar to the user of mobile terminal 302. By connecting Web content 224 with geographical areas, it is possible for mobile terminal 302 to add another dimension to mobile browsing technology. That is to say that searches initiated by mobile terminal 302 during a particular mobile browsing session, may always yield search results that are sensitive to the position of mobile terminal 302 no matter where mobile terminal 302 happens to be located at the time.

In order to connect Web content to geographical areas, each Web page definition may contain a location tag as illustrated by the following code segment:

```
<?xml version=“1.0” ?>
    <MyWebPage>
        ...
        <Location> 60°08′60″N; 24°38′70″E </Location>
        ...
    </MyWebPage>
```

As such, each Web page addressed by URLs contained within registry 332 that pertain to locations 310-320, for example, have an address tag, e.g., <Location>, which defines their respective LOI. Thus, as search engine 306 searches for locations that lie within the AOI specified by mobile terminal 302, the <Location> tag positions are compared to the AOI defined, for example, by circumference 308 and are reported to mobile terminal 302 accordingly. The <Location> tags may be added by the Web page designer, or alternately, may be added by a dynamic content management tool, such as web content management 202.

Other examples may be contemplated whereby location information is embedded within the Web page content. XHTML includes, for example, a head element that contains general information called meta-information about a document. The head element, for example, may include a meta element that provides location information about the Web page that may be relevant to the location of the mobile browser. Alternatively, an eXtensible Markup Language (XML) file may also be created and linked to the Web page, to define location properties that are related to the Web page, in much the same way that Cascading Style Sheets (CSS) are used to control the style and layout of the Web page.

The location information may also include related parameters such as a definition of a validity area, time validity, and location related access rights. The validity area parameter may, for example, function similarly as the <LocationAccuracy> tag as discussed above, whereby users whose location is within the validity area parameter have privity to view the Web page in accordance with the location related access rights. Conversely, although the location related access rights have been met, the time validity parameter may preclude viewing the Web page contents due to a time of day constraint that falls outside the time validity parameter.

Thus, while the mobility aspects of mobile communications may have provided somewhat of a hindrance to the mobile browsing results of the past, use of the present invention offers several new possibilities to mobile Web browsing. For example, imagine a Nordic vacation to the inland city destination of Tampere, Finland. While you and your family are traveling within the city to sample some of its famous black sausage and other amenities, you discover that the gas gauge of the rental car you are driving reads empty. Since you are unaware of any local service stations in the area, you consult the “Geographical Search” menu option that is embedded within the tools menu of your mobile web browser.

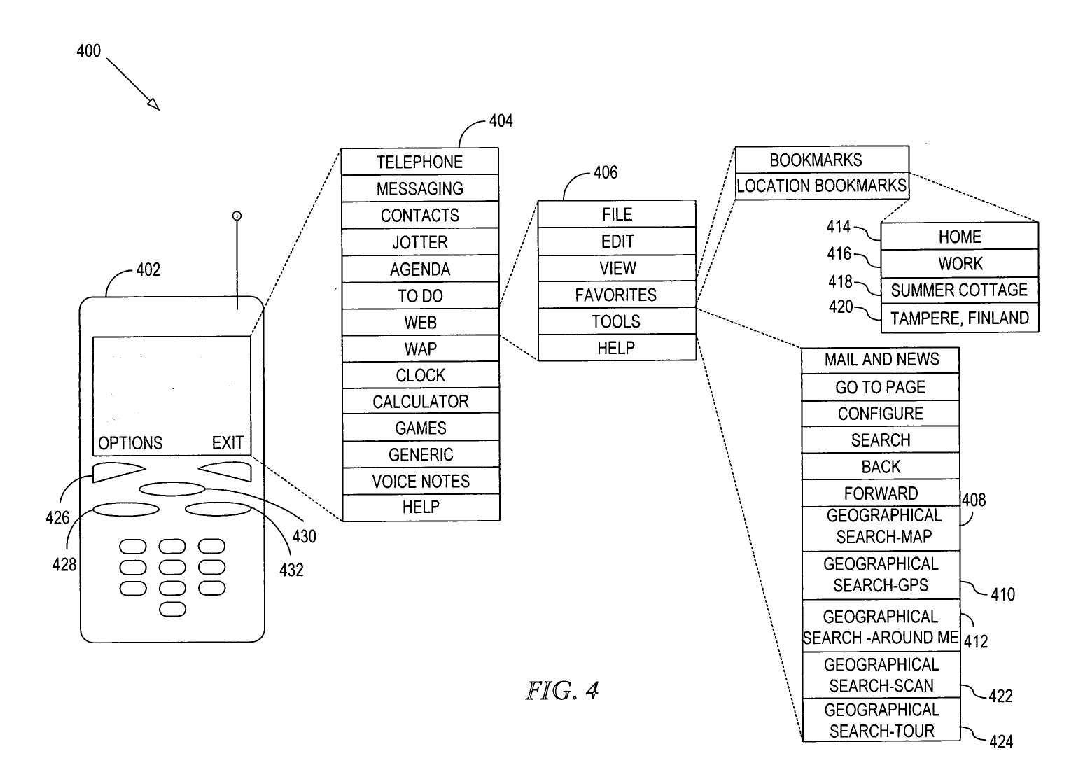

In particular, drop down menu options 400 of FIG. 4 illustrates a typical traversal of a mobile web browser taken by the user of mobile terminal 402 when a Geographical Search is to be initiated. The user of mobile terminal 402 first navigates through sub-menus 404 and 406 to obtain the Web browsing tools necessary for the Geographical Search browsing session. By pressing options key 426 once, sub-menu 404 pops up to allow user interaction with the various options of sub-menu 404. By pressing either up key 428 or down key 432, one of the various options of sub-menu 404 may be highlighted and ultimately selected by pressing select key 430.

For example, once sub-menu 404 is instantiated, option “TELEPHONE” may be the highlighted option of sub-menu 404, whereby 6 key presses of down key 432 highlights option “WEB”. One key press of select key 430 instantiates the “WEB” sub-menu 406, followed by 4 subsequent key presses of down key 432 to highlight option “TOOLS” of WEB sub-menu 406. One press of select key 430 instantiates the TOOLS sub-menu, allowing the user to initiate one of Geographical Search options 408-412 and 422-424 as desired.

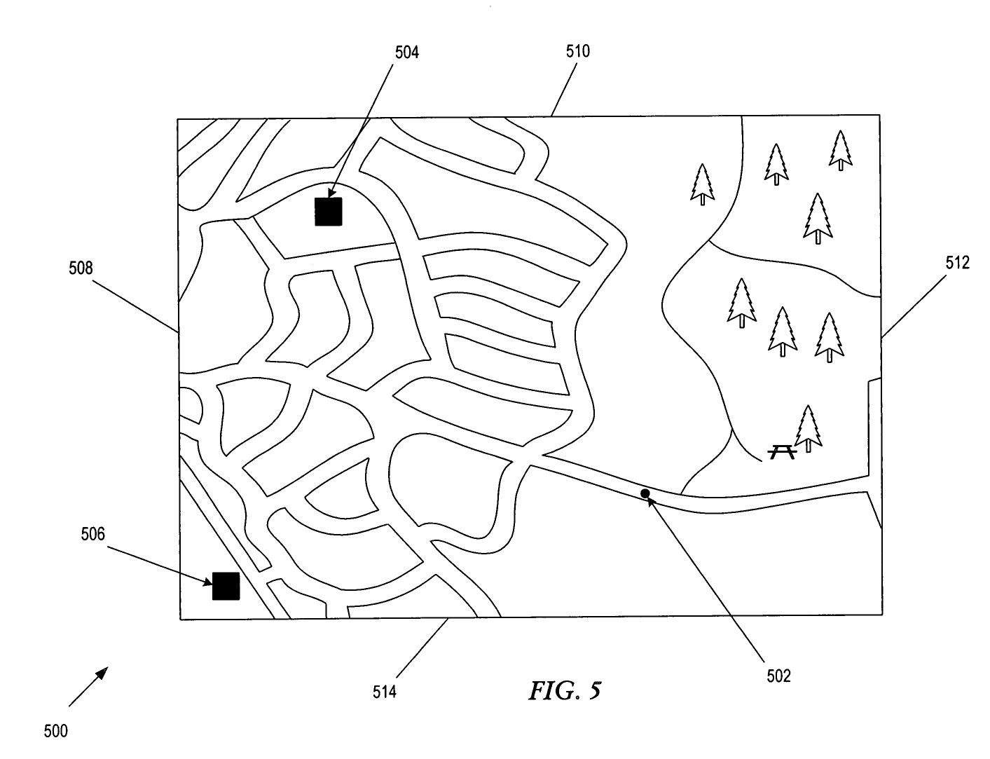

If the user wishes to initiate a map based Geographical Search, for example, then GEOGRAPHICAL SEARCH-MAP option 408 is to be selected, which projects a map similar to map 500 of FIG. 5 onto the display of mobile terminal 402. Map 500 may be generated, for example, from mobile terminal position sensitive data gathered from a map server (not shown) accessed by Web server 304. In particular, mobile terminal 402 presents its current position information, e.g., via HTTP header field <MyLocation> within message 322, so that Web server 304 may intelligently gather map data that is relative to the user's current position indicated by the <MyLocation> header field. The map data is then rendered onto the display of mobile terminal 402 in accordance with programmable display capabilities such as display width and height parameters that are determined by geometric pair dimensions 508, 512 and 510, 514 respectively.

Once map 500 has been displayed, the user of mobile terminal 402 may then use a pointing device, e.g., stylus or cursor, available on mobile terminal 402 to select his approximate location 502 on map 500. Once selected, the user may then enter a keyword such as “gas stations” to initiate a map based Geographical Search for gas stations that are in the proximity defined by area parameters 508-514. Once the search has completed, the results may be plotted on map 500 as blocks 504 and 506, whereby blocks 504 and 506 represent the two closest gas stations that are relative to the user's current position 502.

Web content that is associated with gas stations 504 and 506 may also be accessed via the browser of mobile terminal 402 after the search results are displayed. Additional information such as: services offered, e.g., dining facilities, restroom facilities, etc.; payment methods available, e.g., pay at the pump, Visa, MasterCard, etc.; and pricing information related to the products and services offered, may aid the user in his decision as to which of gas stations 504 and 506 he wishes to patronize.

After having filled the rental car with gasoline, you and your family finally arrive at your original destination of downtown Tampere. As you stroll through the streets of Tampere, you realize that you have no idea where to locate the black sausage and other shops that may be of interest. Activation of GEOGRAPHICAL SEARCH-GPS option 410 serves to remedy your predicament, since your GPS enabled mobile terminal has continued to track your current position. Thus, submission of keywords, e.g., “shopping”, to the Geographical Search browsing session along with your automatically updated GPS position, causes Web server 304 to query search engine 306 as to the location of all shops that are within walking distance (or some other programmable distance) of the user's current GPS position.

A map similar to that of map 500 may then be rendered onto the display of mobile terminal 402, whereby the user's current position and relative positions of all “shops” that are in proximity to the user are displayed. Web page content associated with each “shop” is then readily viewable as well from the mobile terminal's browser. In such an instance, virtual window shopping of all shops that carry black sausage and other commodities that the user may wish to purchase may be experienced. Thus, once the virtual window shopping experience has completed, the user and his family (with the knowledge gained through their virtual window shopping experience) may physically enter the shop(s) of their choice confident that they will find the black sausage that they now have come to crave.

Having completed the planned activities for the day, you and your family find yourselves with plenty of daylight remaining, but with a shortage of ideas for continued activity. Selection of GEOGRAPHICAL SEARCH-AROUND ME option 412 may then be activated to aid in the location of other activities that may be of interest. In this scenario, the mobile terminal's current position does not require the precision of GPS. Rather, the mobile terminal's position as reported by base station 104, for example, suffices to define the AOI. In other words, the circumference of cell 110 defines the user's AOI and is then submitted to the Geographical Search browsing session with no keyword.

The results of such a search request provides all Web pages that lie within the area covered by cell 110. Such results may graphically be represented as illustrated, for example, in FIG. 5, or may be listed in tabular order of preference in a search results window of the mobile browser. Each Web page may then be visited in turn, so that you and your family may plan your next physical stop within the area covered by cell 110.

Once the search results discussed above in relation to the Geographical Search browsing session initiated by Geographical Search menu options 408-412 have been obtained, they may be advantageously stored for future use along with others that have been previously stored. In particular, each set of search results may be stored, for example, within the LOCATION BOOKMARKS folder of sub-menu 406. In such an instance, each of location based bookmarks 414-420 are associated with a particular location as illustrated, for example, in Table 1.

TABLE 1

| BOOKMARK HEADING | LOCATION |
|---|---|
| HOME | 60°08′62″N; 24°38′66″E |
| WORK | 60°08′67″N; 24°38′64″E |
| SUMMER COTTAGE | 60°08′62″S; 24°38′64″E |
| TAMPERE, FINLAND | 60°08′62″N; 24°38′64″E |

The location based bookmark relating to Tampere, Finland, for example, is associated with location <60°08′62″N; 24°38′64″E> as previously determined, for example, while driving within the city of Tampere on family vacation. Sub-folder headings may exist below bookmark heading Tampere, Finland entitled, for example, “gas stations”, “shopping”, and “things to do”, whereby each sub-folder heading contains links to Web content found during the GEOGRAPHICAL SEARCH-MAP option 408, GEOGRAPHICAL SEARCH-GPS option 410, and GEOGRAPHICAL SEARCH-AROUND ME option 412 Geographical Search browsing sessions respectively, as discussed above.

It should be noted that while many Web content browsing embodiments presented herein are referenced to the position of the user, i.e., user centric, other browsing embodiments are contemplated that are not user centric. For example, the GEOGRAPHICAL SEARCH-MAP option 408 may be utilized by the user to plan a future trip, whereby the locations of interest are not related to the user's current position, but are rather related to the user's planned position at a future point in time. In particular, a resident of Finland may wish to tour the eastern coast of the United States (U.S.), but the user is particularly fond of one hotel chain. Accordingly, the user may invoke GEOGRAPHICAL SEARCH-MAP option 408 to first plot the eastern coastline of the U.S. and then to plot all locations of hotel properties that are in the user's favorite hotel chain that lie along the eastern coastline.

In such an instance, the browser of the mobile terminal first issues search requests for location tagged Web content that not only meet the geographic boundaries specified by the eastern coastline of the U.S., but also satisfy the keyword associated with the user's favorite hotel chain. Once rendered, the user is then free to view Web page content that is associated with each hotel that matches the user's geographic and keyword constraints. Such Web page content may then be used to obtain other information, such as pricing and featured amenities, to help the user in the planning stages of his future trip. The user may then bookmark those hotel Web pages that most closely match his desired itinerary to serve as waypoints during the trip.

Thus, the location based browser of mobile terminal 402 provides Web content links and associated waypoints within the location bookmark storage area, such that they can be recalled at any time to the user's advantage. As a bookmark management feature, for example, mobile terminal 402 may optionally be configured to automatically update content contained within each of location based bookmarks 414-420. In a particular embodiment, the mobile browser may update each location based bookmark of Table 1 by automatically submitting search requests to Web server 304, whereby the AOI is determined in part by the location parameters of Table 1 that are associated with each bookmark.

As such, any new Web content that becomes active within each AOI is then updated within the appropriate sub-folder of location based bookmarks 414-420. Then, once the user has a need to view the content previously bookmarked, for example during the family's next visit to Tampere, Finland, it will have been automatically updated for immediate access. That is to say, for example, that any new gas stations having been put into service since their last trip to Tampere, will have been updated within the “gas stations” sub-folder of location based bookmark 420. Thus, subsequent needs for gas station locations while in the Tampere area simply requires a recall of the “gas stations” sub-folder of the Web browser. Upon such a recall, for example, map data similar to that rendered in FIG. 5 may result to reveal any such additions to the active gas stations within the Tampere area.

In an alternate embodiment, the order in which location based folders 414-420 are arranged may depend upon the user's current location. If, for example, the user is at work, then sub-folder 416 moves to the top of the list above sub-folders 414, and 418-420. In addition, the history of visited links within sub-folder 416 may be monitored, such that the links within sub-folder 416 may be placed into descending order according to popularity. Additionally, the content of the most popular link within the location based folder may remain active on the user's display. Thus, for example, if the user frequently monitors stock market trends while at work, his mobile terminal's browser may be optionally configured to: detect that the user is currently within the AOI denoted as “work”; access history metrics to determine that the URL representing the user's favorite stock market Web site is the most popular URL of the “work” sub-folder; and automatically display the Web content of the URL relating to the stock market Web site while the user is within the boundaries of the AOI denoted as “work.”

The present invention may be used to continuously update the user with Web content that is based upon his current position. For example, as the user becomes mobile throughout the AOIs defined by location based bookmarks 414-420, for example, the Web content relating to each respective “most popular” URL within each bookmark may be displayed by the mobile terminal as the user traverses each AOI. That is to say, for example, that once the user leaves the “work” AOI in order to enter the “home” AOI, then the user's most popular URL relating to the “home” bookmark will be visible via the mobile terminal's web browser. If, for example, the user frequently visits a URL that lists the local television stations and their respective programming schedules, then that URL may statistically be the user's favorite while at “home.” Accordingly, if the user wishes to determine the current television broadcast scheduling while in the “home” AOI, all the user need do is consult the Web page that has automatically been displayed by his mobile browser in response to his presence within the “home” AOI.

In an alternate embodiment, the current position of the mobile terminal may determine which Web contents are displayed by the mobile browser irregardless of the user's position in relation to the location based bookmarks 414-420. That is to say, that a scan mode may be executed, e.g., through selection of GEOGRAPHICAL SEARCH-SCAN option 422 of FIG. 4, whereby any of the positioning techniques discussed in relation to FIG. 1 may be used to determine the user's location. Once the user's location is determined, then the Web content that is most relevant to the user's position is fetched by the mobile browser and subsequently displayed to the user.

In such an embodiment, short range access point 124 is contemplated to provide the user with convenience, for example, when strolling down a particular city street that is filled with LOIs, for example, those LOIs that qualify as restaurants. In order to aid the user in his decision as to which restaurant he will patronize, the user invokes GEOGRAPHICAL SEARCH-SCAN option 422 to establish contact with short range access points 124 via communication technologies such as RFID, Bluetooth, WLAN, etc., that may be associated with each restaurant. Several interactive steps may then commence to automatically provide the user with information about the proximately located restaurant.

First, the location and identification of each access point is conveyed to the mobile terminal via a communication session invoked between the short range access point and the mobile terminal. Next, the access point identification is compared to the search keyword, e.g., “restaurant”, entered by the user during scan mode to determine whether the access point relates to a restaurant. If the access point does relate to a restaurant, then the mobile terminal transmits, for example, an HTTP request to its Web server to request the Web content associated with the restaurant. The HTTP request contains the <MyLocation> header field, which is set to be equal to the location of the restaurant. In addition, the HTTP request contains the associated <LocationAccuracy> header field, which is set for fine resolution, such that only the Web content associated with the restaurant will be returned to the mobile terminal. Thus, as the user strolls down the city street making contact with multiple LOIs, he may automatically receive Web content that is associated those LOIs, e.g., restaurants, that are within proximity of the user and that are of interest to the user. Such Web content may contain the current menu, pricing list, wine list, etc., that may be used to aid the user in his restaurant selection.

Scan mode may also allow the user to maintain a “theme” page that remains active within the “theme” window and is regularly updated according to the user's current position as provided, for example, by the mobile terminal's visiting base station. For example, the user may be a particularly loyal customer of petroleum refining company, “gas-X”. As such, the user may create his own “gas-X” browser window, such that the content of the “gas-X” browser window is updated with the Web content relating to the “gas-X” filling station that is closest to the user's current position. Thus, scan mode is particularly beneficial when the user is traveling through unknown territory on an empty gas tank. In such an emergency, all the user need do is consult his “gas-X” window, which automatically contains the most up-to-date information concerning the nearest “gas-X” filling station, so that driving directions and hours of operation, for example, may be obtained to avert the crisis.

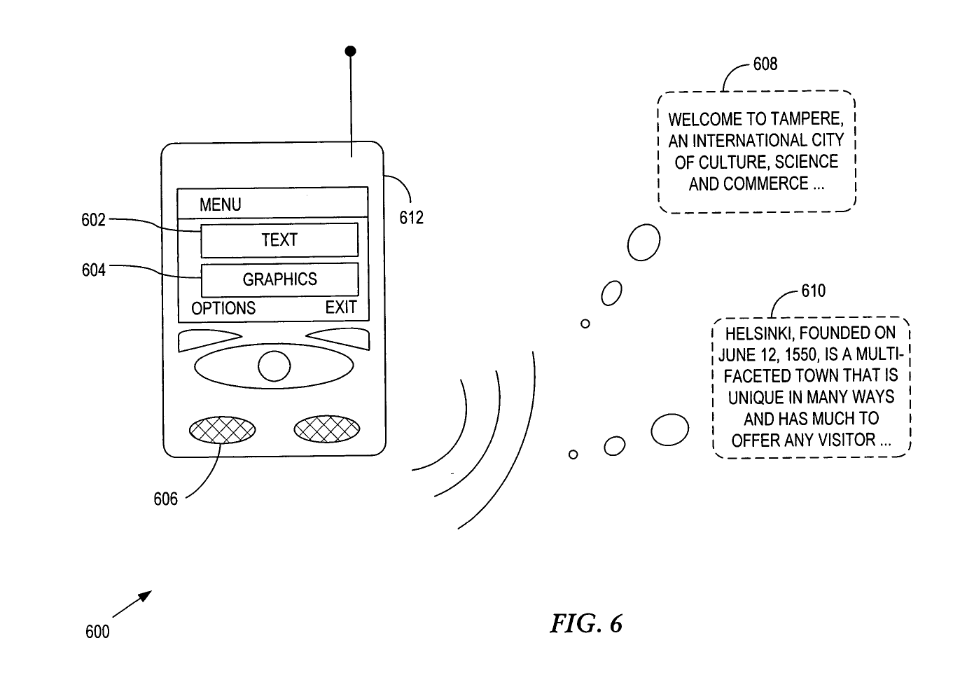

In an alternate embodiment in accordance with the present invention, the location sensitive Web content that is presented to the user by virtue of his location is optionally combined with Text to Speech (T2S) technology, such that the user may be kept audibly informed as to the textual portions of the changing Web content. In other words, as the location sensitive Web content is being downloaded to the user's mobile terminal, the textual portions of the Web content may be detected by the T2S and audibly presented to the user via speakers 606 of mobile terminal 612 as illustrated in T2S diagram 600 of FIG. 6.

The T2S embodiment exemplified in FIG. 6 of the present invention is particularly useful for the “hands-free” user who is traversing several AOIs, by automobile for example, and wishes to be kept informed of each AOI while driving through them. In such an embodiment, a tour mode may be initiated through selection of GEOGRAPHICAL SEARCH-TOUR option 424 of FIG. 4, whereby the user enters a keyword of interest, e.g., “touring”, to the Geographical Search browsing session and further indicates several AOIs, e.g., Tampere and Helsinki, that are of interest during such a tour mode.

Once mobile terminal 612 detects that it has entered the first AOI, e.g., Helsinki, it generates a request to its Web server for tourist information regarding Helsinki from a Web page containing tourist information about Helsinki. Contained within the response to the request are textual portions 602 and graphical portions 604 relating to the Web content associated with Helsinki, which are automatically rendered onto the display of mobile terminal 612. In addition, the T2S module executing within mobile terminal 612 optionally converts text 602 into speech, e.g., 610, of a programmable language type, e.g., English, such that the user of mobile terminal 612 receives audible narrative 610 that is translated by the T2S from textual portion 602. In this way, mobile terminal 612 acts as a virtual tour guide of Helsinki, Finland.

Similarly, as the user enters the AOI associated with Tampere, mobile terminal 612 generates a request to its Web server for tourist information regarding Tampere from a Web page containing tourist information about Tampere. Contained within the response to the request are textual portions 602 and graphical portions 604 relating to the Web content associated with Tampere, which are automatically rendered onto the display of mobile terminal 612. In addition, the T2S module executing within mobile terminal 612 optionally converts text 602 into speech, e.g., 608, of a programmable language type, e.g., English, such that the user of mobile terminal 612 receives audible narrative 608 that is translated by the T2S from textual portion 602. In this way, mobile terminal 612 acts as a virtual tour guide of Tampere, Finland.

As an alternate embodiment of GEOGRAPHICAL SEARCH-TOUR option 424, the user may indicate an LOI and an associated perimeter around the LOI, such that the user may be alerted when he is close to the LOI, i.e., within the specified perimeter of the LOI. For example, the user may enter his favorite restaurant chain as the LOI during a particular journey. Once embarked, the user's mobile terminal continuously monitors its location relative to the locations of each restaurant within a proximity of the mobile terminal. Once the user's position has come within the perimeter, e.g., 1 kilometer, of the closest restaurant, the mobile terminal then alerts the user as to the location of the restaurant. The alert may occur in any number of various ways, to include audible, visual, or tactile feedback to the user. The visual alert mode, for example, may include a rendering of the Web page associated with the restaurant that the user is close to.

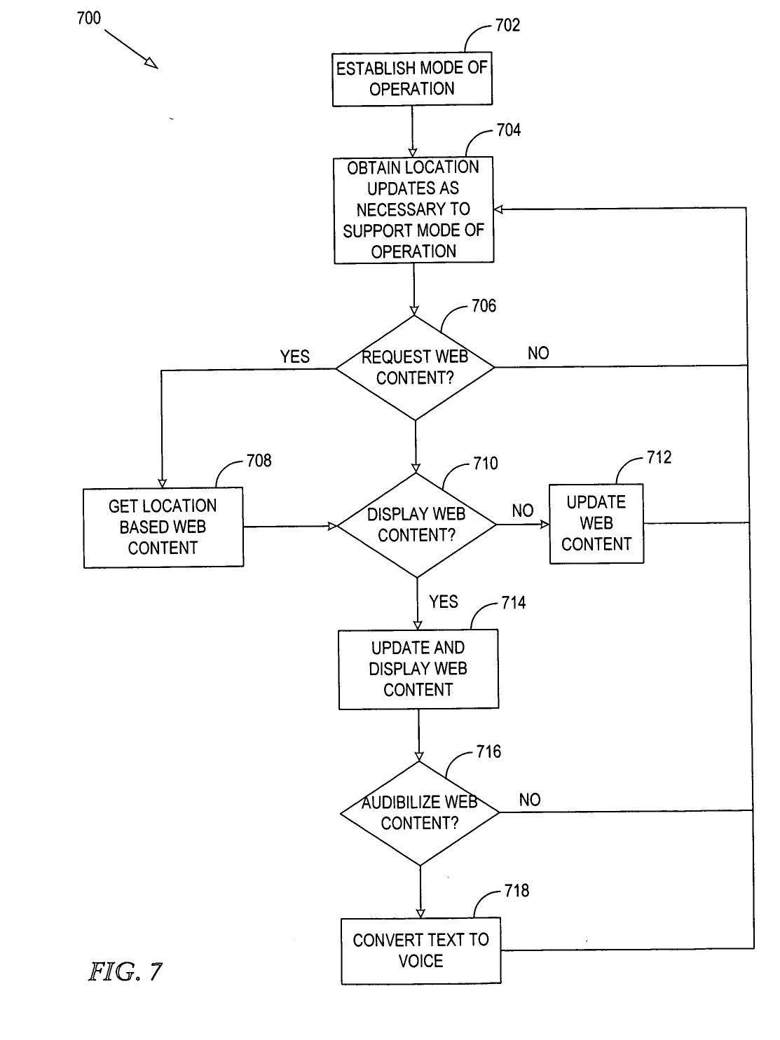

It can be seen, therefore, that the present invention is useful in any number of various scenarios where Web content based on a mobile user's location may be used to enhance the mobile user's browsing experience. FIG. 7 illustrates exemplary flow diagram 700 of a high level browsing method in accordance with the present invention that incorporates such a location sensitive browsing experience. In step 702, a browsing method, e.g., Geographical Search options 408-412 and 422-424, may be selected via WEB sub-menu 406. In step 704, location updates to the mobile terminal are conducted as discussed above in relation to FIG. 1.

Location based Web content may then be requested by the mobile terminal as in step 706-708, whereby HTTP header fields <MyLocation> and <LocationAccuracy>, for example, may be used by the mobile terminal to indicate its location parameters to the appropriate Web server. Other location parameters not related to the user's position, however, may also be used by the mobile terminal to receive Web content relating to, for example, position information relative to a map. Examples of map data may not only include terrestrial locations relative to the planet Earth, but may also include extra-terrestrial locations such as the Sun, Moon, and other galaxies. Thus, the present invention is not limited to those locations that are (currently) within the reach of today's mobile terminal user.

Web content that is geographically linked using, for example, <Location> tags within the markup definitions of the Web content, may then be compared to the mobile terminal's location parameters to determine the location relevance of the Web content. If the Web content is of relevance, but the user does not wish to be bothered with any visual/audible updates as verified in step 710, then the appropriate bookmarks, browser cache, and other storage locations within the mobile terminal may be updated with the relevant Web content for future use as in step 712.

If, on the other hand, the user wishes to be personally updated with the current Web content relating to his requested location parameters, then step 714 updates the user's browser windows accordingly. Textual portions of the Web content may also be audibly experienced as in step 716-718, when optional T2S operations are being used by the mobile terminal to convert textual portions, e.g., 602, of Web content to audible voice, e.g., 608-610. In this way, the user may experience any location sensitive Web content received during a “hands-free” mode of operation, even though the user is pre-occupied while driving, sailing, flying, or otherwise unable or unwilling to focus his visual attention to the newly received Web content.

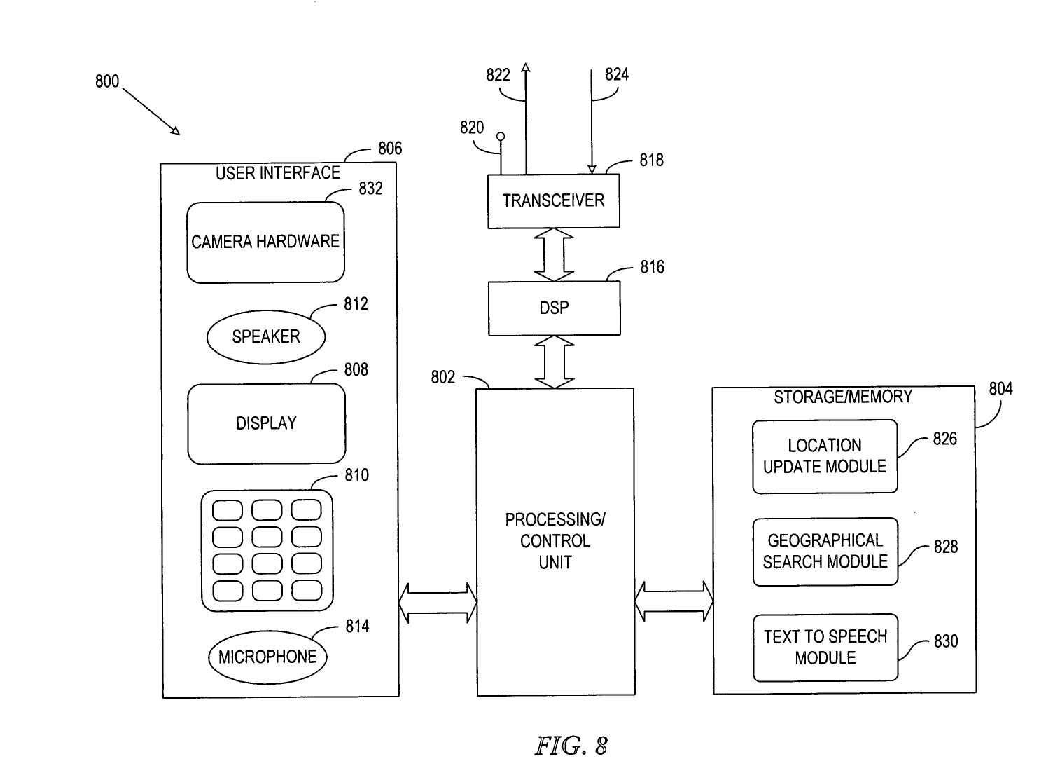

The invention is a modular invention, whereby processing functions within either a mobile terminal or a hardware platform may be utilized to implement the present invention. The mobile terminals may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various location based functions described herein. An example of a representative mobile terminal computing system capable of carrying out operations in accordance with the invention is illustrated in FIG. 8. Those skilled in the art will appreciate that the exemplary mobile computing environment 800 is merely representative of general functions that may be associated with such mobile devices, and also that landline computing systems similarly include computing circuitry to perform such operations.

The exemplary mobile computing arrangement 800 suitable for location based functions in accordance with the present invention may be associated with a number of different types of wireless devices. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by location module 826, Geographical Search module 828, and T2S module 830 available in the program storage/memory 804. Thus, the processing unit 802 is capable of defining and managing location based functions associated with the present invention, and is further able to provide “hands-free” location based functions using T2S module 830. The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, camera hardware 832, and microphone 814. These and other user-interface components are coupled to the processor 802 as is known in the art. Other user-interface mechanisms may be employed, such as voice to command converters, text to voice converters, switches, touch pad/screen, graphical user interface using a pointing device, trackball, joystick, or any other user interface mechanism.

The mobile computing arrangement 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals 822 and receives the incoming radio signals 824 associated with the wireless device.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a location sensitive system and method in accordance with the present invention.

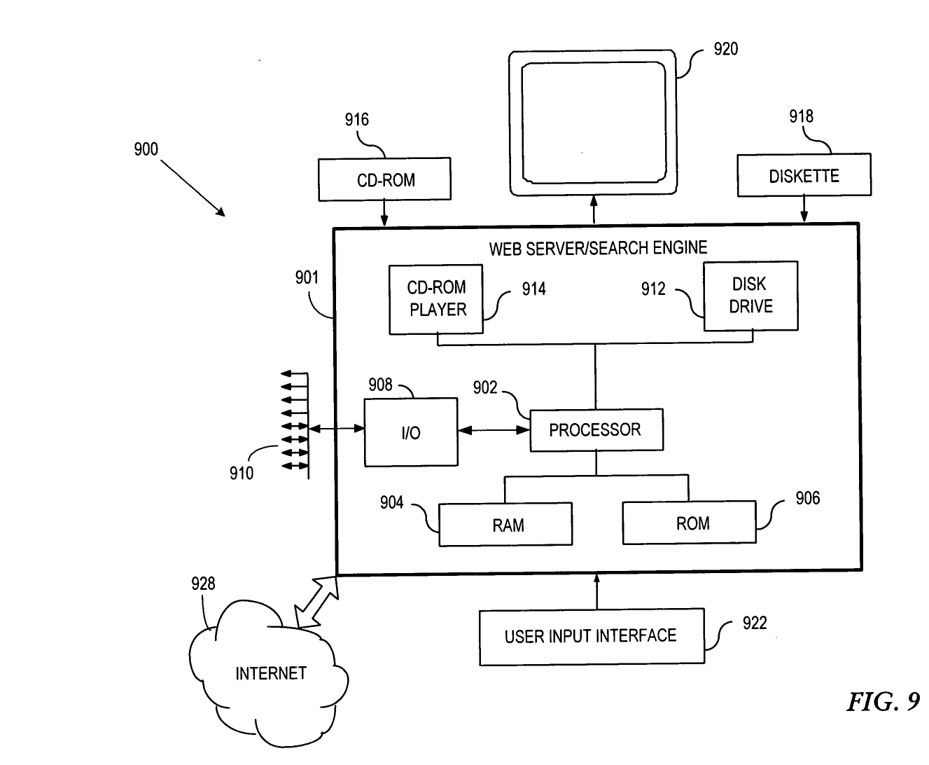

The Web servers/search engines or other systems for providing server functions in connection with the present invention may be any type of computing device capable of processing and communicating digital information. The server platforms utilize computing systems to control and manage the location based group activity. An example of a representative computing system capable of carrying out operations in accordance with the invention is illustrated in FIG. 9. Hardware, firmware, software or a combination thereof may be used to perform the various location based functions and operations described herein. The computing structure 900 of FIG. 9 is an example computing structure that can be used in connection with such a Web server platform.

The example computing arrangement 900 suitable for performing the Web server activity in accordance with the present invention includes Web server/search engine 901, which includes a central processor (CPU) 902 coupled to random access memory (RAM) 904 and read-only memory (ROM) 906. The ROM 906 may also be other types of storage media to store programs, such as programmable ROM (PROM), erasable PROM (EPROM), etc. The processor 902 may communicate with other internal and external components through input/output (I/O) circuitry 908 and bussing 910, to provide control signals and the like. For example, data received from I/O connections 908 or Internet connection 928 may be processed in accordance with the present invention. External data storage devices may be coupled to I/O circuitry 908 to facilitate Web server functions according to the present invention. Alternatively, such databases may be locally stored in the storage/memory of Web server 901, or otherwise accessible via a local network or networks having a more extensive reach such as the Internet 928. The processor 902 carries out a variety of functions as is known in the art, as dictated by software and/or firmware instructions.

Application server 901 may also include one or more data storage devices, including hard and floppy disk drives 912, CD-ROM drives 914, and other hardware capable of reading and/or storing information such as DVD, etc. In one embodiment, software for carrying out the Web server/search engine operations in accordance with the present invention may be stored and distributed on a CD-ROM 916, diskette 918 or other form of media capable of portably storing information. These storage media may be inserted into, and read by, devices such as the CD-ROM drive 914, the disk drive 912, etc. The software may also be transmitted to Web server/search engine 901 via data signals, such as being downloaded electronically via a network, such as the Internet. Web server/search engine 901 is coupled to a display 920, which may be any type of known display or presentation screen, such as LCD displays, plasma display, cathode ray tubes (CRT), etc. A user input interface 922 is provided, including one or more user interface mechanisms such as a mouse, keyboard, microphone, touch pad, touch screen, voice-recognition system, etc.

Web server/search engine 901 may be coupled to other computing devices, such as the landline and/or wireless terminals via a network. The server may be part of a larger network configuration as in a global area network (GAN) such as the Internet 928, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method of accessing position relevant Web content, comprising:
obtaining a location update relative to a position of a mobile terminal;
forming location criteria from the location update;
including the location criteria in a Web content request from the mobile terminal;
filtering results from the Web content request according to the location criteria to form the position relevant Web content; and
providing the position relevant Web content to the mobile terminal.

2. The method according to claim 1, wherein obtaining the location update comprises receiving location information from a base station wirelessly coupled to the mobile terminal.

3. The method according to claim 1, wherein obtaining the location update comprises receiving location information from a Global Positioning System (GPS).

4. The method according to claim 1, wherein obtaining the location update comprises:
receiving map data associated with a first position of the mobile terminal;
projecting the map data onto a display of the mobile terminal;
indicating a second position of the mobile terminal on the projected map data; and
using the second position as the location update.

5. The method according to claim 1, wherein forming location criteria comprises establishing a location accuracy parameter that defines an area surrounding the location update.

6. The method according to claim 1, wherein the Web content request includes a HyperText Transport Protocol (HTTP) message.

7. The method according to claim 6, wherein the HTTP message presents the location criteria within an HTTP header.

8. The method according to claim 1, wherein the filtering further includes filtering the results from the Web content request according to a search keyword.

9. The method according to claim 8, wherein the providing further includes providing the position relevant Web content that relates to the search keyword.

10. The method according to claim 9, further comprising storing the position relevant Web content in a location bookmark area of the mobile terminal.

11. The method according to claim 10, further comprising periodically updating the position relevant Web content.

12. The method according to claim 11, further comprising categorizing the updated results according to a location heading.

13. The method according to claim 12, wherein the categorized headings are prioritized according to the relative position of the mobile terminal.

14. The method according to claim 11, further comprising automatically displaying the updated results in response to the relative position of the mobile terminal.

15. A geographically based Web content system, comprising:
a mobile terminal geographically located within the Web content system;
a Web server adapted to receive Web content requests from the mobile terminal; and
a search engine coupled to the Web server and adapted to gather location tagged Web content in response to the Web content requests, wherein location tags of the Web content gathered conform to geographical criteria expressed by the mobile terminal in the Web content requests.

16. The geographically based Web content system according to claim 15, wherein the mobile terminal comprises a location update module adapted to maintain a current location of the mobile terminal.

17. The geographically based Web content system according to claim 16, wherein the location update module comprises a Global Positioning System (GPS) module.

18. The geographically based Web content system according to claim 16, wherein the mobile terminal further comprises a geographical search module coupled to the location update module and adapted to convert the current location of the mobile terminal into the geographical criteria contained within the Web content request.

19. The geographically based Web content system according to claim 18, wherein the Web content request includes a HyperText Transfer Protocol (HTTP) header containing the geographical criteria.

20. The geographically based Web content system according to claim 15, wherein the mobile terminal further comprises a text to speech module adapted to convert textual portions of the Web content received from the Web server into audible information.

21. A mobile terminal capable of being wirelessly coupled to a network which includes location tagged Web content, the mobile terminal comprising:
a memory capable of storing a location update module and a geographical search module;
a processor coupled to the memory and configured by the location update module to maintain position information associated with the mobile terminal and configured by the geographical search module to request the location tagged Web content that relates to the position of the mobile terminal; and
a transceiver configured to receive the location tagged Web content from a Web server.

22. The mobile terminal according to claim 21, further comprising a text to speech module adapted to convert textual portions of the location tagged Web content into audible information.

23. A computer-readable medium having instructions stored thereon which are executable by a mobile terminal for requesting location based Web content by performing steps comprising:
obtaining location updates relative to a position of the mobile terminal;
defining an area of interest surrounding the position of the mobile terminal; and
requesting location based Web content that conforms to the area of interest.

24. A Web server capable of being coupled to a network to facilitate a location based Web content search, the Web server comprising:
means for receiving location based Web content requests containing location criteria associated with a location of a mobile terminal;
means for communicating the location based Web content requests to a search engine;
means for receiving responses from the search engine in response to the location based Web content requests; and
means for filtering the responses to conform to the location criteria.

25. A computer-readable medium having instructions stored thereon which are executable by a Web server by performing steps comprising:
receiving Web content requests containing location criteria associated with a location of a mobile terminal;
communicating the Web content requests to a search engine;
receiving responses from the search engine in response to the Web content requests; and
filtering the responses to conform to the location criteria.

26. A mobile terminal capable of being wirelessly coupled to a network which includes Web content, the mobile terminal comprising:
a memory capable of storing a location update module and a geographical search module;
a processor coupled to the memory and configured by the location update module to maintain position information associated with the mobile terminal; and
a user interface adapted to display menu options whose selection configures the geographical search module to issue a search request used to locate the Web content, the menu options comprising:
a general search option that returns Web content irregardless of location tags associated with the Web content and the position information associated with the mobile terminal;
a location search option that returns Web content whose location tags comply with location information provided in the search request; and
a user centric search option that returns Web content whose location tags comply with the position information associated with the mobile terminal that is provided in the search request.

27. The mobile terminal according to claim 26, wherein HyperText Transport Protocol (HTTP) headers contain the location information provided in the search requests associated with the location search option.

28. The mobile terminal according to claim 26, wherein HyperText Transport Protocol (HTTP) headers contain the position information provided in the search requests associated with the user centric search option.

29. A mobile terminal capable of being wirelessly coupled to a network which includes Web content, the mobile terminal comprising:
a memory capable of storing a location update module and a geographical search module;
a processor coupled to the memory and configured by the location update module to maintain a position of the mobile terminal; and
a user interface adapted to display menu options whose selection determines a search request used to locate the Web content, the menu options comprising an automatic search option that configures the geographical search module to automatically issue the search request depending upon the position of the mobile terminal, wherein a HyperText Transport Protocol (HTTP) header in the search request includes the position of the mobile terminal.

30. The mobile terminal according to claim 29, wherein the Web content received in response to the search request is used to update Web content previously bookmarked.

31. The mobile terminal according to claim 30, wherein the bookmarks representing previously received Web content are sorted according to the position of the mobile terminal relative to location information contained within the Web content.

32. A geographically based Web content system, comprising:
a mobile terminal geographically located within the Web content system;
a Web server coupled to receive Web content requests from the mobile terminal; and
a content provider coupled to the Web server, wherein the content provider contains Web pages that include eXtensible Markup Language (XML) to define location information associated with the Web pages.

33. The geographically based Web content system according to claim 32, wherein the location information is contained within a meta tag.

34. The geographically based Web content system according to claim 32, wherein the location information is defined by a location tag.

35. The geographically based Web content system according to claim 32, wherein the location information is contained within an XML file.

36. The geographically based Web content system according to claim 32, wherein the location information further includes location parameters associated with the location information, the location parameters including validity area and access rights.

37. The geographically based Web content system according to claim 36, wherein the mobile terminal is denied access to the Web page if the geographical location of the mobile terminal falls outside of the validity area associated with the Web page.

38. A mobile terminal capable of being wirelessly coupled to a network which includes location tagged Web content, the mobile terminal comprising:
a memory capable of storing a location update module and a geographical search module;
a processor coupled to the memory and configured by the location update module to maintain a position of the mobile terminal; and
a user interface adapted to display menu options whose selection determines a search request used to locate the location tagged Web content, the menu options comprising a tour search option that configures the geographical search module to issue an alarm once the location update module has determined that the mobile terminal has come within a programmable proximity to a location indicated by the location tagged Web content.

39. The mobile terminal according to claim 38, wherein the alarm includes one of an audio, visual, and tactile feedback.

40. The mobile terminal according to claim 39, wherein the visual alarm includes a rendering of the location tagged Web content whose proximity the mobile terminal is within.
